(19) United States
(12) Patent Application Publication
(10) Pub. No.: US 2021/0346804 A1
(43) Pub. Date: Nov. 11, 2021

(54) INFORMATION PROCESSING DEVICE AND NON-TRANSITORY COMPUTER-READABLE MEDIUM

(71) Applicant: SEGA CORPORATION, Tokyo (JP)

(72) Inventor: Takahiro Otomo, Tokyo (JP)

(73) Assignee: SEGA CORPORATION, Tokyo (JP)

(21) Appl. No.: 17/384,254

(22) Filed: Jul. 23, 2021

Related U.S. Application Data
(63) Continuation of application No. PCT/JP2020/002401, filed on Jan. 23, 2020.

(30) Foreign Application Priority Data
Jan. 24, 2019 (JP) 2019-010392

(51) Int. Cl. A63F 13/58; A63F 13/533; A63F 13/822; A63F 3/06; G07F 17/32

(52) U.S. Cl. CPC A63F 13/58; A63F 13/533; G07F 17/329; A63F 3/0645; A63F 13/822

(57) ABSTRACT

An information processing device includes a storage that stores: game tasks of a game to be played by a player; and game contents associated with a player ID of the player as possessed contents possessed by the player; and a processor connected to the storage and a display and that: extracts, from the possessed contents, an evolvable content that can be evolved; determines, from the game tasks, first game tasks that can be selected by the player causes a display to display a selection screen indicating the first game tasks and that receives a game task selected, from the first game tasks, by the player. The processor further determines, from the first game tasks, a second game task related to an evolution of the evolvable content. The selection screen indicates the second game task in a different form from remaining game tasks except for the second game task.

### BACKGROUND

### Technical Field

The present invention generally relates to an information processing device and a non-transitory computer-readable medium (CRM) that stores program instructions.

### Related Art

Conventional games have been known to allow players to perform game disciplines such as lottery games (so-called loot box) and battle games (so-called quests).

In this regard, Patent Document 1 discloses a technique for having a player perform one quest selected by the player from a plurality of quests set in a game.

### Patent Literature

Patent Document 1: Japanese Patent Publication 6160889

In such a game, the player may select a game discipline from a plurality of game disciplines to play. However, a player may be confused about which game discipline to play when, for example, there are a large number of game disciplines to choose from or when the player has played all the available game disciplines. This, in turn, might cause a player to exit the game without fully playing the game disciplines.

### SUMMARY

One or more embodiments provide an information processing device and a program that can increase motivation to play a game.

According to one or more embodiments, an information processing device includes a storage means for storing possessed content possessed by a player, an extraction means for extracting evolvable content that can be evolved from among the possessed content, a specification means for specifying game disciplines that can be selected by the player and that are related to the evolution of the evolvable content, and a control means for outputting a selection screen for receiving a selection of game disciplines to be played by the player, wherein the control means outputs the specified game discipline in a different form from other game disciplines in the selection screen.

In the information processing device according to one or more embodiments, the control means outputs the fact that the specified game discipline is related to the evolution of the evolvable content on the selection screen.

In the information processing device according to one or more embodiments, the control means registers in advance the evolvable content that the player wishes to evolve according to instructions for the evolvable content from the player, and the extraction means extracts the registered evolvable content.

In the information processing device according to one or more embodiments, the extraction means extracts, from among the possessed content, evolvable content for which evolution has become newly enabled by an update to the game.

In the information processing device according to one or more embodiments, the specification means specifies, as a game discipline related to the evolution of the evolvable content, a game discipline for which resource content that is missing from the possessed content can be acquired, from among the resource content associated with evolvable content.

In the information processing device according to one or more embodiments, the specification means specifies, as a game discipline related to evolution of the evolvable content, a quest that is at a lower level than the quest for which the evolution of said evolvable content is enabled upon completion and that the player has not yet completed.

In the information processing device according to one or more embodiments, the specification means specifies, as a game discipline related to the evolution of the evolvable content, a lottery game that is at a lower level than the lottery game for which the evolution of said evolvable content is enabled by playing and that the player has not yet played.

A program, according to one or more embodiments, causes a computer to function as a storage means for storing possessed content possessed by a player, an extraction means for extracting evolvable content that can be evolved from among the possessed content, a specification means for specifying game disciplines that can be selected by the player and that are related to the evolution of the evolvable content, and a control means for outputting a selection screen for receiving a selection of game disciplines to be played by the player, and the control means outputs the specified game discipline in a different form from other game disciplines on the selection screen.

One or more embodiments make it possible to improve operability of the game. Further, according to one or more embodiments, motivation to play a game can be increased.

### BRIEF DESCRIPTION OF THE DRAWINGS

FIG. 1 is a block diagram illustrating an example of the overall configuration of a game system including an information processing device (computer) according to one or more embodiments.

FIG. 2 is a diagram schematically illustrating an example of the hardware configuration of a server device.

FIG. 3 is a block diagram schematically illustrating an example of the functional means of a server device.

FIG. 4 is a flowchart illustrating an example (Example 1) of the process flow for the output of the quest selection screen.

FIG. 5 is a diagram illustrating an example of a quest selection screen.

FIG. 6 is a diagram illustrating an example of a quest execution selection screen for a quest directly related to evolution.

FIG. 7 is a diagram illustrating an example of a quest execution selection screen for a quest indirectly related to evolution.

FIG. 8 is a diagram illustrating an example of a quest execution selection screen for a quest that is not related to evolution.

FIG. 9 is a flowchart illustrating an example (Example 2) of the process flow for the output of a lottery game selection screen.

FIG. 10 is a diagram illustrating an example of a lottery game selection screen.

FIG. 11 is a diagram illustrating an example of a lottery game execution selection screen for a lottery game directly related to evolution.

FIG. 12 is a diagram illustrating an example of a lottery game execution selection screen for a lottery game indirectly related to evolution.

FIG. 13 is a diagram illustrating an example of a lottery game execution selection screen for a lottery game that is not related to evolution.

### DETAILED DESCRIPTION

Embodiments of the present invention will be described below with reference to the drawings. In order to facilitate understanding of the description, the same symbol is applied to the same components and steps in each drawing as far as possible, and redundant explanations are omitted.

### Overall Configuration

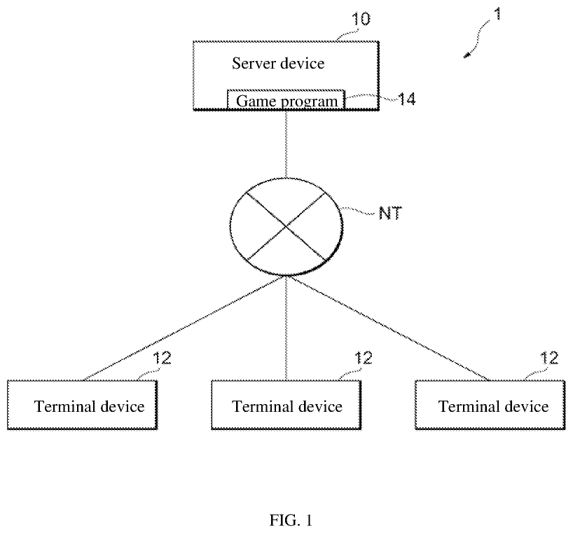

FIG. 1 is a block diagram illustrating an example of the overall configuration of a game system 1 including an information processing device (computer) according to one or more embodiments.

As illustrated in FIG. 1, the game system 1 is a system for providing a game to one or a plurality of players. The game system 1 is provided with a server device 10 as an information processing device and one or a plurality of terminal devices 12 according to one or more embodiments. The server device 10 and terminal devices 12 are connected to each other for communication via a communication network NT such as an intranet or the Internet.

The server device 10 is an information processing device that provides a game obtained by executing a game program 14, or the game program 14 itself, to each terminal device 12 via the communication network NT. In one or more embodiments, the server device 10 provides a game to each terminal device 12 by executing the game program 14 and transmitting and outputting the execution results (image data, audio data, and the like) to each terminal device 12. The game program 14 may be cooperatively executed by the terminal devices 12 and the server device 10.

Each terminal device 12 is an information processing device possessed by a player that provides a game to the player by outputting the execution results of the game program 14 received from the server device 10. These terminal devices 12 can be, for example, a variety of video game consoles, portable game consoles, arcade game consoles, smartphones, tablets, personal computers, and the like. Each terminal device 12 is connectable to the server device 10 via the communication network NT. Each terminal device 12 may provide a game to a player by downloading a game program 14 from the server device 10 and executing the game program 14 therein. The game program 14 may be stored in a non-transitory computer-readable medium (CRM).

### Hardware Configuration

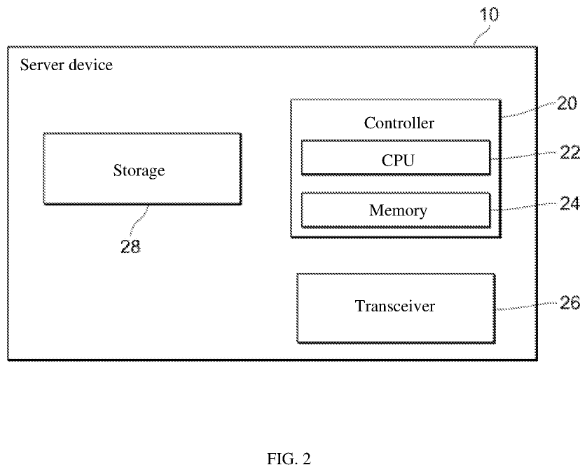

FIG. 2 is a diagram schematically illustrating an example of the hardware configuration of the server device 10.

As illustrated in FIG. 2, the server device 10 has a controller 20, a transceiver 26, and a storage 28. The controller 20 includes a CPU (Central Processing Unit) 22 (processor) and memory 24.

In the controller 20, the CPU 22 functions as various functional means by executing a prescribed program stored in the memory 24, storage 28, or the like. The details of this functional means will be described later.

The transceiver 26 includes a communication interface or the like for communicating with external devices. The transceiver 26, for example, transmits and receives various types of information to and from the terminal devices 12.

The storage 28 is comprised by a hard disk or the like. The storage 28 stores various programs and various information necessary for execution of processing in the controller 20, including the game program 14, and information on processing results. In one or more embodiments, the storage 28 may store game tasks of a game to be played by a player and game contents associated with a player ID of the player as possessed contents possessed by the player.

Note that the server device 10 can be realized using an information processing device such as a dedicated or general-purpose server computer. The server device 10 may be comprised by a single information processing device or a plurality of information processing devices distributed over the communication network NT. In addition, FIG. 2 illustrates only a portion of the main hardware configuration that the server device 10 possesses, and the server device 10 can be equipped with other configurations that are generally provided to servers. The hardware configuration of the plurality of terminal devices 12 can also be similar to that of the server device 10, but they may also be equipped with operation means, display devices, and sound output devices, for example.

### Game Overview

Games according to one or more embodiments include game disciplines such as lottery games (loot box) and battle games (quests) in which characters can be acquired as an example of content, as well as fusion games in which acquired characters can be enhanced or evolved. In one or more embodiments, the game disciplines may be referred to as game tasks.

A lottery game according to one or more embodiments is a game in which a player acquires one or a plurality of characters randomly selected from a group of characters to be drawn, based on an instruction (request) from the player to execute the lottery game. This lottery is performed based on the consumption of credits by the player. Credits can include, for example, paid items, game items excluding paid items (non-paid items, tickets, game coins, and the like). Paid items are game items that can be used in the game which are purchased through actual payment. Non-paid items are game items that have the same value as paid items and are mainly given in the game.

Lottery games according to one or more embodiments include incremental lottery games (so-called step-up loot boxes) and lottery games with a fixed open period (so-called event loot boxes). In an incremental lottery game, for example, the player must play lottery game C1 to be able to play lottery game C2. In such a case, lottery game C1 is referred to as one level lower than lottery game C2, and lottery game C2 is referred to as one level higher than lottery game C1. Furthermore, if, for example, the settings are such that a player cannot play lottery game C3 without playing lottery game C2, lottery game C1 is referred to as two levels lower than lottery game C3, and lottery game C3 is referred to as two levels higher than lottery game C1.

A quest according to one or more embodiments is a game in which an enemy character is pitted against a deck consisting of one or a plurality of characters possessed by the player, based on instructions (requests) from the player to perform the quest. The player instructs the characters in the deck to attack and the like to play the battle game, and if the player completes the quest, the player is rewarded with a completion reward. Completion rewards include non-paid items, game coins, enemy characters that appeared in the quest (including evolution resource characters), and experience value to increase player rank.

Moreover, quests according to one or more embodiments include incremental quests (so-called normal quests) and quests with a fixed open period (so-called event quests). In an incremental quest, for example, the player must complete quest Q1 before they can play quest Q2. In such a case, quest Q1 is referred to as one level lower than quest Q2, and quest Q2 is referred to as one level higher than quest Q1. Furthermore, if, for example, the game is set up so that players must complete quest Q2 before they can play quest Q3, then quest Q1 is referred to as two levels lower than quest Q3, and quest Q3 is referred to as two levels higher than quest Q1.

A fusion game according to one or more embodiments is a game in which a resource character is fused into a fusion source character. In the fusion game, as the first character fusion, an enhancement fusion is performed whereby one or a plurality of resource characters are fused to the fusion source character so as to change the character's ability parameters. In this first character fusion, if the fusion source character and the resource character are of the same character family, an enhancement fusion is performed where the skill level of at least the fusion source character is changed (improved). On the other hand, in the first character fusion, if the fusion source character and the resource character are not of the same character family, an enhancement fusion is performed where at least the level of the fusion source character is changed (improved) and its skill level is not changed (not improved). Note that characters in the same family are characters with the same character ID or the same character at different stages of evolution. For example, a character K and a character N, which is three evolutions ahead of character K, are in the same character family.

In addition, in the fusion game according to one or more embodiments, as a second character fusion, an evolution fusion is performed whereby the fusion source character is evolved into a different character (an evolved character) on the condition that the player possesses all the evolution resource characters stored (associated) in the evolution conditions of the fusion source character.

In the fusion game according to one or more embodiments, a character used as a resource (resource character) in the first or second character fusion is deemed not possessed by the player. For example, when performing the first character fusion, the player selects the enhancement fusion menu, specifies the fusion source character and resource character, and gives instructions for an enhancement fusion, to fuse the fusion source character with the resource character. Or, for example, when performing the second character fusion, the player selects the evolution fusion menu, specifies the fusion source character, and gives instructions for the evolution fusion, to fuse all the evolution resource characters associated with the fusion source character.

### Functional Means

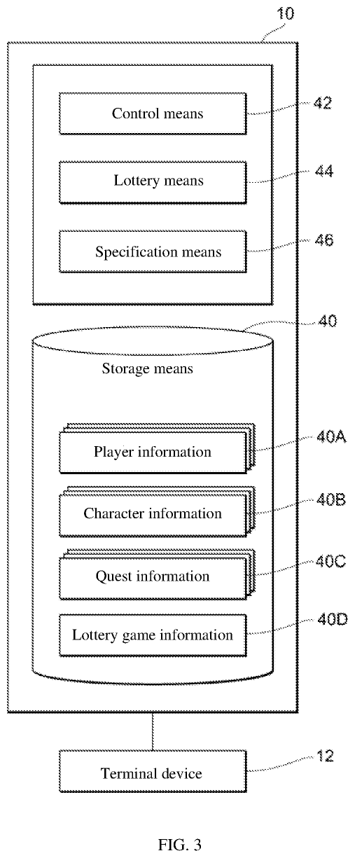

FIG. 3 is a block diagram schematically illustrating an example of the functional means of the server device 10.

As illustrated in FIG. 3, the server device 10 is provided with functional means such as a storage means 40, a control means 42, an extraction means 44, and a specification means 46. The storage means 40 is realized by one or a plurality of storages 28. The functional means other than the storage means 40 are realized by the controller 20 executing the game program 14 stored in the storage 28 or the like. All or part of these functional means may also be provided in the terminal device 12. The server device 10 need only be connectable to the storage means 40, and may be connected inside the server device 10 or outside the server device 10. In other words, the server device 10 itself need not be provided with the storage means 40. In this case, the storage means 40 is provided in another server device or the like. In addition, it goes without saying that the storage means 40 may calculate coefficients and various variables for the stored data and output them when there is a request to refer to or acquire certain data.

The storage means 40 has functionality for storing player information 40A, character information 40B, quest information 40C, lottery game information 40D, and the like.

The player information 40A is stored for each player in association with the player ID of said player. This player information 40A includes, for example, the player's name, age, player rank, possessed character information, current stamina value, possessed item information, quest completion information, lottery gameplay information, and the like. Possessed character information includes information on the characters that the player possesses, such as the ability parameters of each character (level, skill level, hit points, attack power, defense power, and the like). The current stamina value is a value that is consumed when a player executes a quest. For example, this current stamina value is recovered according to the use of stamina recovery items (paid items, non-paid items, and the like) and the passage of time. Possessed item information includes the number of paid items, non-paid items, game coins and other game items possessed by the player. Quest completion information stores the quest IDs of the quests that have been completed by the player up to now. Lottery gameplay information stores the lottery game IDs of the lottery games that have been played by the player up to now.

The character information 40B is stored for each character and is associated with the character ID of said character. The character information 40B includes, for example, the name, character image, rarity, initial and maximum values of ability parameters, skills, and evolution fusion information for each character. A skill is an ability that a character can activate during or after a game. In one or more embodiments, a skill is, for example, an ability to make an item appear that recovers hit points during a game, an ability to reduce the amount of damage caused by an attack from an enemy character, an ability to increase the number of characters that can be acquired after a game, and the like. The higher the skill level, the higher the activation probability and the activated effect. The evolution fusion information stores the evolution conditions and the character IDs of the evolved characters. Evolution conditions store the character IDs of one or a plurality of evolution resource characters associated with the character (fusion source character).

If a character (fusion source character) can be evolved, the evolution conditions and the character ID of the evolved character are stored in the evolution fusion information according to one or more embodiments. In other words, this evolution fusion information is not stored if the character (fusion source character) is not able to evolve. In addition, when a character has a plurality of evolution destinations, the evolution fusion information stores the character IDs (evolution conditions) of one or a plurality of evolution resource characters associated with each evolution destination and the character IDs of the characters after the respective evolutions.

The quest information 40C is stored for each quest in association with the quest ID of said quest. The quest information 40C includes the name of the quest, enemy character information, stamina consumption values, play requirements, and other information. Enemy character information includes ability parameters, drop rates, experience values, the number of game coins, and the like, associated with the character ID of each enemy character appearing in the quest. The drop rate is the probability that the player will acquire an enemy character as a reward for completing a quest, and the higher the difficulty of the quest, the higher the probability is set. The experience value and the number of game coins are values that are earned by players as rewards for completing quests. The stamina consumption value is a value that is consumed from the player's current stamina value when the player performs a quest, and the higher the difficulty of the quest, the higher the value is set. The play requirements store, for example, the fact that the quest one level lower has been completed or the open period (date and time) of the event, and the like.

The lottery game information 40D is stored for each lottery game in association with the lottery game ID of said lottery game. The lottery game information 40D includes the name of the lottery game, lottery target information, number of characters to be acquired, credit, play requirements, and other information. The lottery probabilities are stored in the lottery target information, in association with the character IDs of the characters that are the lottery targets in the lottery game (lottery target characters). The number of characters to be acquired by the player in one lottery game is stored in the number of characters to be acquired. As credits, the number of game items such as paid items, non-paid items, game coins, and the like are stored as the credits required to execute the lottery game. In addition, a higher price is set for lottery games where the number of characters to be acquired is large or where characters with high rarity can be easily acquired. The play requirements store, for example, the fact that the lottery game one level lower has been played, the open period (date and time) of the event, and the like.

The control means 42 has functionality for controlling the game in response to the operations of the player at the terminal device 12. In one or more embodiments, the control means 42 outputs a selection screen to the terminal device 12 for receiving a selection from a player of a game discipline to be played. In this selection screen, the control means 42 outputs the game disciplines related to the evolution of possessed characters in a different form than the other game disciplines.

For example, the control means 42 may output on this selection screen that the game discipline associated with the evolution is associated with the evolution of possessed characters.

Moreover, for example, the control means 42 may pre-register a character that the player wishes to evolve in response to instructions from the player with respect to the possessed character.

The extraction means 44 has functionality for extracting characters that can be evolved (hereinafter referred to as an “evolvable character”) from among the possessed characters. In one or more embodiments, the extraction means 44 extracts the evolvable characters from among the possessed characters of the player, based on whether or not evolution fusion information is stored in the character information 40B of said possessed character.

For example, from among the possessed characters of the player, the extraction means 44 may extract characters that the player has registered in advance as characters that the player wishes to evolve, or characters whose evolution has become newly enabled by an update to the game.

The specification means 46 has functionality for specifying game disciplines that are selectable by the player and that are related to character evolution. For example, the specification means 46 may specify, as a game discipline directly related to the evolution of evolvable characters, a quest for which the evolution of said evolvable characters is enabled by completing the quest. The specification means 46 may, for example, specify, as a game discipline indirectly related to the evolution of the evolvable character, a quest that is at a lower level than the quest for which the evolution of said evolvable character is enabled upon completion and that has not yet been completed by the player.

In addition, for example, the specification means 46 may specify, as a game discipline directly related to the evolution of evolvable characters, a lottery game for which the evolution of said evolvable character is enabled by playing. Moreover, the specification means 46 may, for example, specify, as a game discipline indirectly related to the evolution of the evolvable character, a lottery game that is at a lower level than the lottery game for which the evolution of said evolvable character is enabled by playing and that has not yet been played by the player.

Here, examples of game disciplines related to character evolution (quests and lottery games in which character evolution is enabled) include game disciplines where one or a plurality of evolution resource characters associated with said character can be acquired, or game disciplines in which evolution resource characters that the player does not possess (missing from the possessed characters) can be acquired from among said evolution resource characters.

### Process Flow of Selection Screen Output

### Example 1

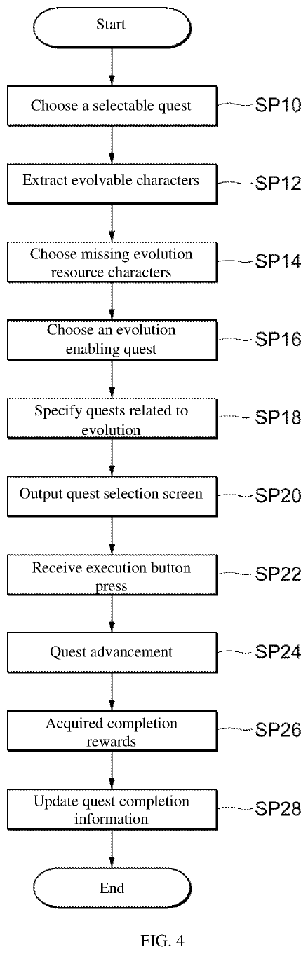

FIG. 4 is a flowchart illustrating an example (Example 1) of the process flow for the output of the quest selection screen. This process is initiated, for example, when a player selects the menu of incremental quests. The order and details of the following steps may be changed as appropriate.

(Step SP10)

The control means 42 refers to the quest completion information in the player information 40A and the play requirements in the quest information 40C to choose a quest that a player can select (hereinafter referred to as a “selectable quest”). Specifically, the control means 42 chooses quest Q1 to quest Q9 as selectable quests when, for example, quest Q1 to quest Q8 are stored in the quest completion information and completion of a quest that is one level lower (quest Q8) is stored in the play requirements of quest Q9. Then, the process moves to the process of step SP12.

(Step SP12)

The extraction means 44 refers to the possessed character information in the player information 40A and the evolution fusion information in the character information 40B to extract a character for which the evolution fusion information is stored as a character that can be evolved (hereinafter referred to as an “evolvable character”) from among the possessed characters. In other words, the CPU 22 extracts, from the possessed characters, an evolvable character that can be evolved. Then, the process moves to the process of step SP14.

(Step SP14)

The specification means 46 refers to the possessed character information in the player information 40A and the evolution fusion information in the character information 40B to choose one or a plurality of evolution resource characters associated with the evolvable character extracted in the above step SP12 that the player does not possess (is missing). In other words, the CPU 22 determines whether the evolution resource characters include an evolution resource character (first resource content) that is not associated with the player ID. The evolution resource character that is not associated with the player ID means the resource character that is not possessed by the player. Then, the process moves to the process of step SP16.

(Step SP16)

The specification means 46 chooses a quest for which the evolution of the evolvable character is enabled upon completion (hereinafter referred to as an “evolution enabling quest”). In one or more embodiments, the specification means 46 refers to the enemy character information in the quest information 40C to choose a quest in which the missing evolution resource character chosen in the above step SP14 can be acquired. Then, the process moves to the process of step SP18.

(Step SP18)

The specification means 46 specifies the selectable quests chosen in step SP10 above as directly related to the evolution from among the evolution enabling quests chosen in step SP16 above. The specification means 46 then refers to the play requirements of the quest information 40C to specify a selectable quest that is at a lower level than the evolution enabling quest and that has not yet been completed by the player, as a quest indirectly related to the evolution. The process then moves to the process of step SP20. In one or more embodiments, the selectable quests (quests indirectly related to evolution) that have not yet been completed by the player are the highest level of the quests among the selectable quests. In other words, when the quests include a first quest and a second quest that can be played after the first quest is completed by the player, the CPU 22 determines whether the second quest has been completed by the player.

(Step SP20)

The control means 42 outputs (displays) a quest selection screen to the terminal device 12 for receiving selection of a quest to be played from a player. In one or more embodiments, the control means 42 outputs to the terminal device 12 a quest selection screen showing a list of the selectable quests chosen in the above step SP10. Furthermore, on this quest selection screen, the control means 42 outputs the quests specified as a quest directly or indirectly related to evolution in step SP18 above in a different form than quests not related to evolution (other quests).

For example, if the CPU 22 determines that the evolution resource character includes the evolution resource character (first resource content) that is not associated with the player ID, the CPU 22 causes the display to display a game task for which the first resource content can be acquired.

For example, if the CPU 22 determines that the second quest has not been completed by the player, the CPU 22 causes the display to display the second quest on the selection screen.

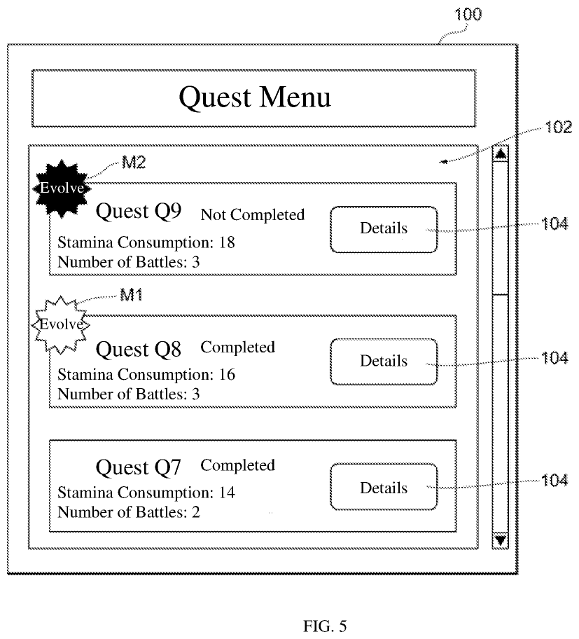

FIG. 5 is a diagram illustrating an example of the quest selection screen 100.

As illustrated in FIG. 5, the quest selection screen 100 is provided with a quest information region 102 and a details button 104. The name of each selectable quest, whether the quest is completed or not, and the stamina consumption values thereof are arranged in the quest information region 102. In the quest information region 102, quests that are directly related to evolution have a mark M1 affixed thereto and quests that are indirectly related to evolution have a mark M2 affixed thereto, and are displayed in a different form from quests that are not related to evolution (other quests). The highest level quest in the quest information region 102 may be marked with both mark M1 and mark M2. The details button 104 is arranged in association with each of the selectable quests. When the details button 104 is pressed, a quest execution selection screen is displayed, depending on whether the associated quest is directly related to evolution, indirectly related to evolution, or not related to evolution.

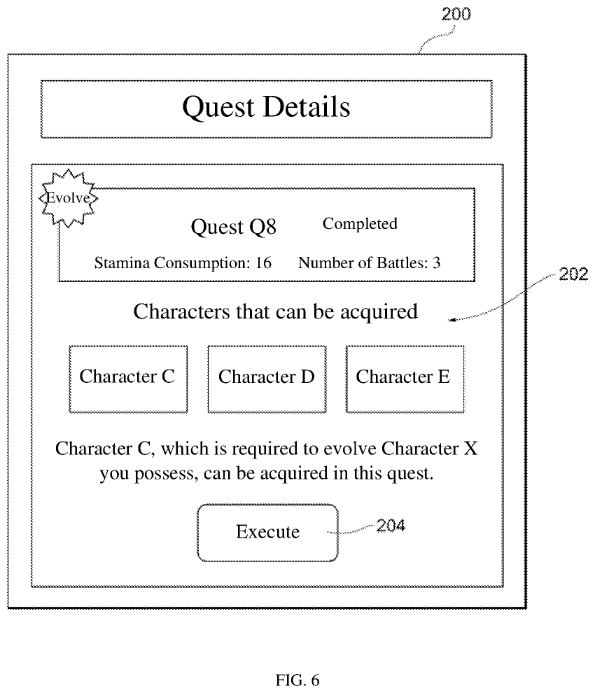

FIG. 6 is a diagram illustrating an example of the quest execution selection screen 200 for a quest directly related to evolution.

As illustrated in FIG. 6, the quest execution selection screen 200 is provided with a quest details information region 202 and an execution button 204. The quest details information region 202 indicates that, in addition to the characters that can be acquired by the quest, evolution resource characters that are required (missing) for the evolution of a possessed evolvable character (character X) can be acquired (the fact that the quest is directly related to the evolution of the evolvable character). When the execution button 204 is pressed, the player can execute the quest.

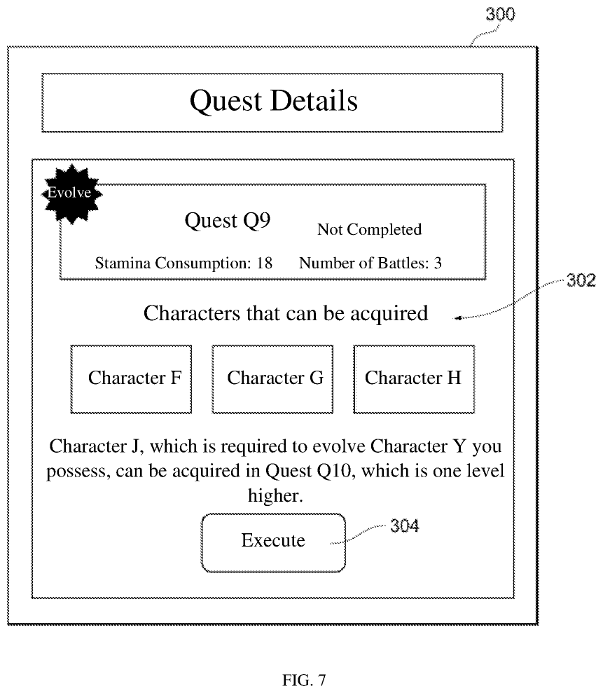

FIG. 7 is a diagram illustrating an example of the quest execution selection screen 300 for a quest indirectly related to evolution.

As illustrated in FIG. 7, the quest execution selection screen 300 is provided with a quest details information region 302 and an execution button 304. The quest details information region 302 indicates that, in addition to the characters that can be acquired by the quest, evolution resource characters that are required (missing) for the evolution of a possessed evolvable character (character Y) can be acquired by a higher level quest (the fact that the quest is indirectly related to the evolution of the evolvable character).

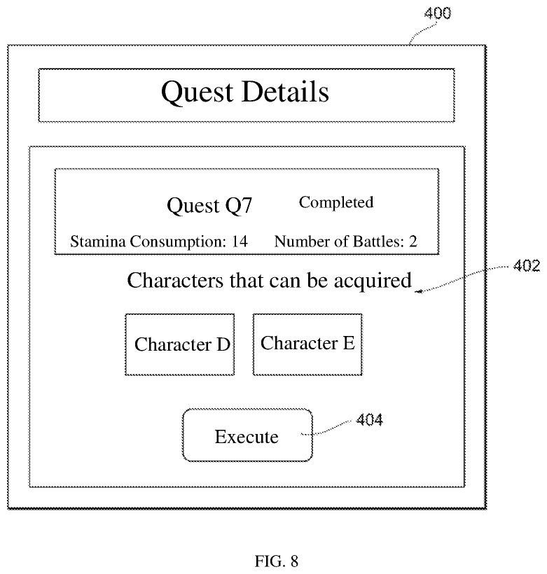

FIG. 8 is a diagram illustrating an example of the quest execution selection screen 400 for a quest that is not related to evolution.

As illustrated in FIG. 8, the quest execution selection screen 400 is provided with a quest details information region 402 and an execution button 404. The quest details information region 402 indicates the characters that can be acquired in the quest.

Returning to FIG. 4, the process moves to the process of step SP22.

(Step SP22)

The control means 42 receives the pressing of the execution button (selection instruction) by a player on the above quest execution selection screen. Then, in response to the execution button being pressed, the process moves to the process of step SP24.

(Step SP24)

The control means 42 advances the quest for which the execution button is pressed. In one or more embodiments, the control means 42 accepts selection of a deck from the player to be used in said quest, and consumes the player's current stamina value to advance in the battle game in which the selected deck (character in the deck) and one or a plurality of enemy characters appear. Specifically, the control means 42 advances the battle game using the ability parameters of each of the characters in the deck and the ability parameters of each of the enemy characters. Then, the process moves to the process of step SP26.

(Step SP26)

The control means 42 allows the player to earn a completion reward based on the player completing the quest. Specifically, the control means 42 determines characters, experience values, and the like to be acquired by referring to the drop rates, experience values, and the like in the enemy character information in the quest information 40C, and enables the player to acquire such characters, experience values, and the like. Then, the process moves to the process of step SP28.

(Step SP28)

The control means 42 updates the quest completion information in the player information 40A. In one or more embodiments, the control means 42 updates the quest completion information by adding the quest ID if the quest completed by the player was a not-yet-completed quest. The process then completes the series of processes illustrated in FIG. 4.

### Example 2

In example 1 above, in step SP20 above, it was explained that the control means 42 outputs a selection screen related to the quest in a different form, depending on whether or not the quest is related to evolution. However, it is also possible to output the selection screen related to a lottery game in a different form, depending on whether or not it is related to a lottery game.

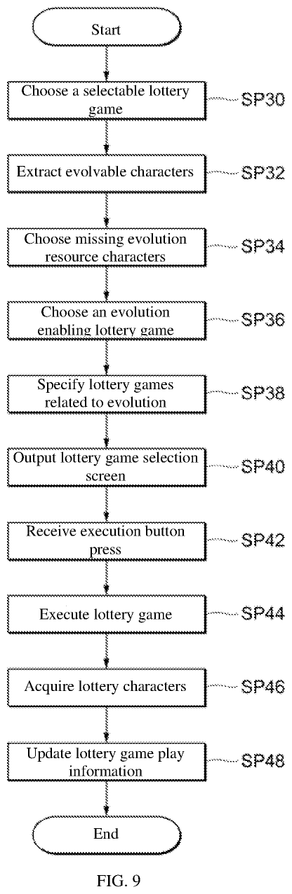

FIG. 9 is a flowchart illustrating an example (Example 2) of the process flow for the output of the lottery game selection screen. This process is initiated, for example, when a player selects the menu of incremental lottery games.

(Step SP30)

The control means 42 refers to the lottery game play information in the player information 40A and the play requirements in the lottery game information 40D to choose a lottery game that the player can select (hereinafter referred to as the “selectable lottery game”). Specifically, if, for example, lottery game C1 to lottery game C3 are stored in the lottery game play information and the play requirements for playing lottery game C4 are that the lottery game that is one level lower (lottery game C3) has been played, the control means 42 chooses lottery game C1 to lottery game C4 as the selectable lottery games. Then, the process moves to the process of step SP32.

(Step SP32 to Step SP34)

The processes in step SP32 to step SP34 are the same as the processes in step SP12 to step SP14 described above, and the descriptions are therefore omitted. The process then moves to the process of step SP36.

(Step SP36)

The specification means 46 chooses a lottery game for which the evolution of an evolvable character is enabled by playing (hereinafter referred to as an “evolution enabling lottery game”). In one or more embodiments, the specification means 46 refers to the lottery target information in the lottery game information 40D to choose a lottery game in which the missing evolution resource character chosen in the above step SP34 can be acquired. Then, the process moves to the process of step SP38.

(Step SP38)

The specification means 46 specifies the selectable lottery games chosen in step SP30 above as lottery games directly related to evolution from among the evolution enabling lottery games chosen in step SP36 above. The specification means 46 then refers to the play requirements in the lottery game information 40D to specify a selectable lottery game that is at a lower level than the evolution enabling lottery game and that has not yet been played by the player, as a lottery game indirectly related to evolution. The process then moves to the process of step SP40. In one or more embodiments, the selectable lottery games (lottery games indirectly related to evolution) that have not yet been played by the player are the highest level of the lottery games among the selectable lottery games.

(Step SP40)

The control means 42 outputs (displays) a lottery game selection screen to the terminal device 12 for receiving selection of a lottery game to be played from a player. In one or more embodiments, the control means 42 outputs to the terminal device 12 a lottery game selection screen showing a list of the selectable lottery games chosen in the above step SP30. Furthermore, on this lottery game selection screen, the control means 42 outputs lottery games specified as a lottery game directly or indirectly related to evolution in step SP38 above in a different form than lottery games not related to evolution (other lottery games).

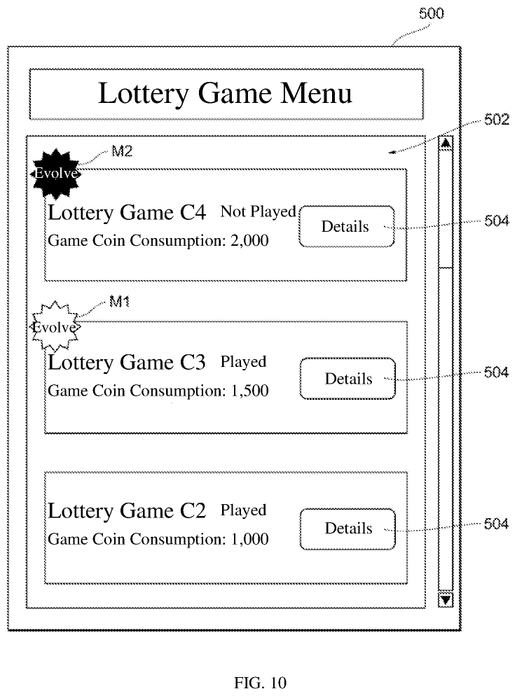

FIG. 10 is a diagram illustrating an example of a lottery game selection screen 500.

As illustrated in FIG. 10, the lottery game selection screen 500 is provided with a lottery game information region 502 and a details button 504. The name of each selectable lottery game, whether the game had been played or not, and the consumption value of game coins are arranged in the lottery game information region 502. In the lottery game information region 502, lottery games that are directly related to evolution have a mark M1 affixed thereto and lottery games that are indirectly related to evolution have a mark M2 affixed thereto, and are displayed in a different form from lottery games that are not related to evolution (other lottery games). The highest level lottery game in the lottery game information region 502 may be marked with both mark M1 and mark M2. The details button 504 is arranged in association with each of the selectable lottery games. When the details button 504 is pressed, a lottery game execution selection screen is displayed depending on whether the associated lottery game is a lottery game directly related to evolution, indirectly related to evolution, or not related to evolution.

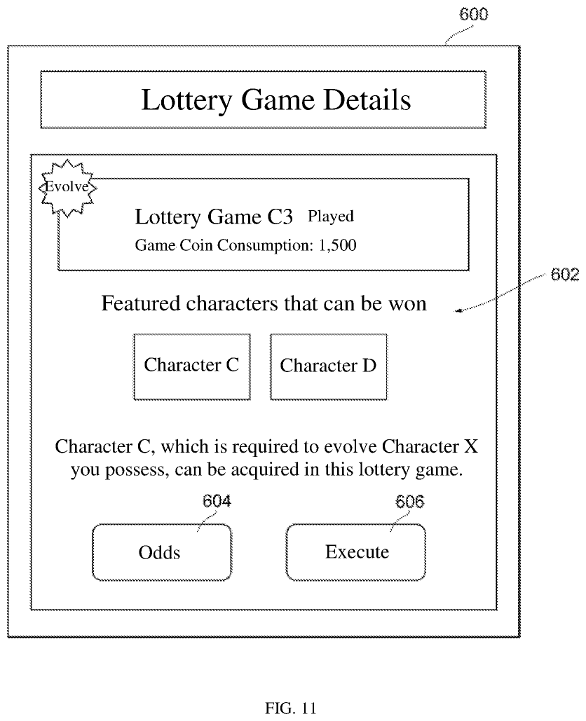

FIG. 11 is a diagram illustrating an example of the lottery game execution selection screen 600 for a lottery game directly related to evolution.

As illustrated in FIG. 11, the lottery game execution selection screen 600 is provided with a lottery game details information region 602, an odds button 604, and an execution button 606. The lottery game details information region 602 indicates that, in addition to the featured characters that can be acquired in the lottery game, evolution resource characters that are required (missing) for the evolution of the possessed evolvable character (character X) can be acquired (the fact that the lottery game is directly related to the evolution of the evolvable character). When the odds button 604 is pressed, a screen indicating the lottery probability and the like for each of the lottery target characters is displayed. When the execution button 606 is pressed, the player can execute the lottery game.

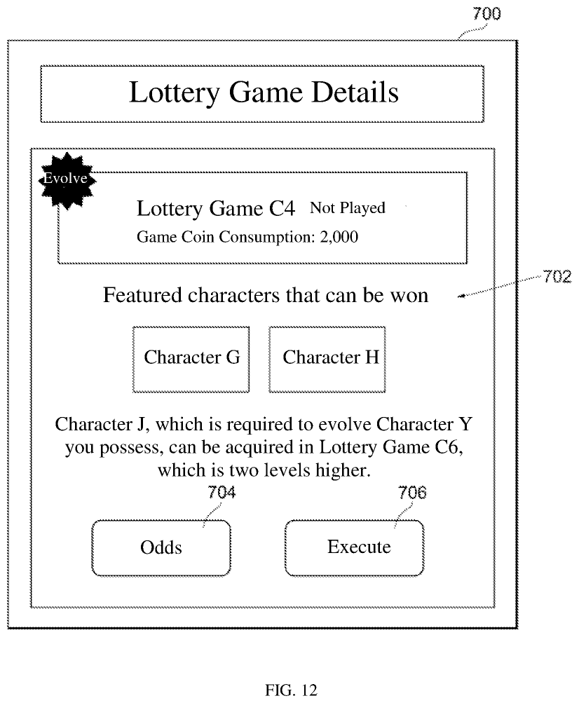

FIG. 12 is a diagram illustrating an example of the lottery game execution selection screen 700 for a lottery game indirectly related to evolution.

As illustrated in FIG. 12, the lottery game execution selection screen 700 is provided with a lottery game details information region 702, an odds button 704, and an execution button 706. The lottery game details information region 702 indicates that, in addition to the featured characters that can be acquired in the lottery game, evolution resource characters that are required (missing) for the evolution of possessed evolvable character (character Y) can be acquired in a higher level lottery game (the fact that the lottery game is indirectly related to the evolution of the evolvable character).

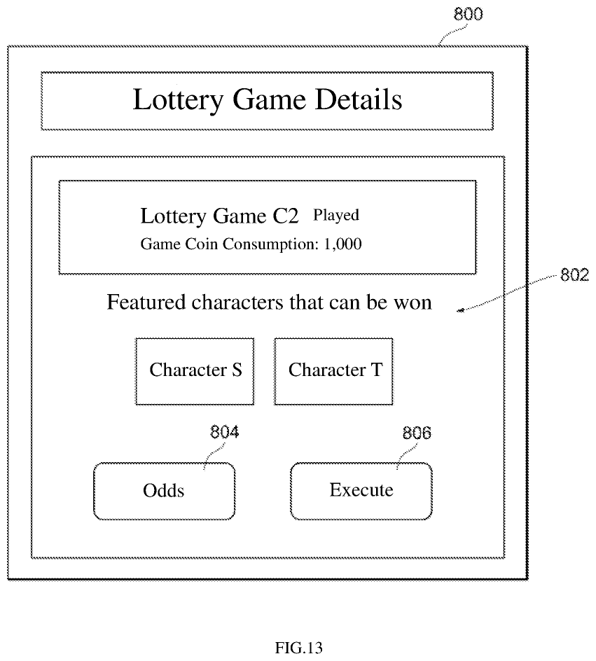

FIG. 13 is a diagram illustrating an example of the lottery game execution selection screen 800 for a lottery game that is not related to evolution.

As illustrated in FIG. 13, the lottery game execution selection screen 800 is provided with a lottery game details information region 802, an odds button 804, and an execution button 806. The lottery game details information region 802 indicates the featured characters that can be acquired in the lottery game.

Returning to FIG. 9, the process moves to the process of step SP42.

(Step SP42)

The control means 42 receives the pressing of an execution button (selection instruction) by a player on the above lottery game execution selection screen. Then, in response to the execution button being pressed, the process moves to the process of step SP44.

(Step SP44)

The control means 42 executes the lottery game in which the execution button is pressed. In one or more embodiments, the control means 42 consumes the game coins possessed by the player to play the selected lottery game. Specifically, the control means 42 randomly selects a character to be acquired by the player based on the lottery probability of each of the lottery target characters in the lottery target information in the lottery game information 40D. Then, the process moves to the process of step SP46.

(Step SP46)

Based on the fact that the player has played the lottery game, the control means 42 causes the player to acquire the character drawn in step SP44. The process then moves to the process of step SP48.

(Step SP48)

The control means 42 updates the lottery game play information in the player information 40A. In one or more embodiments, the control means 42 updates the lottery game information by adding the lottery game ID if the lottery game played by the player was a not-yet-played lottery game. The process then completes the series of processes illustrated in FIG. 9.

### Example 3

In the examples as described above, in the step SP12 and the step SP32 above, it was explained that evolvable characters are extracted from the possessed characters of the player. However, the extraction means 44 may extract only the evolvable characters that the players have registered in advance as characters that they wish to evolve.

As an example of registering a character that the player wishes to evolve in advance, when the player selects the menu for registering a possessed character that the player wishes to evolve, the control means 42 outputs to the terminal device 12 a list of evolvable characters extracted from the possessed characters by the extraction means 44 and registers the evolvable characters in response to instructions from the player with regard to these outputted evolvable characters. The registered characters may be stored in the player information 40A.

Moreover, the control means 42 may, for example, register a possessed character that cannot evolve as a character that the player wishes to evolve in response to an instruction from the player. In other words, a player may register a possessed character that the player wishes to evolve in anticipation that the possessed character will enabled for evolution by a future update to the game.

Also, in the step SP12 or the step SP32 above, the extraction means 44 may extract, for example, a character (evolvable character) for which the evolution fusion information in the character information 40B is stored from among the characters registered in advance as characters in the deck used by the player in the quest.

### Example 4

In the step SP12 and the step SP32 above, the extraction means 44 may extract, for example, the evolvable characters from among the possessed characters for which evolution has become newly enabled by an update to the game. A game update refers to a version upgrade or update of the game, in which new evolution conditions and character IDs of the evolved characters are stored in the evolution fusion information of the character information 40B. For example, the extraction means 44 extracts evolvable characters (possessed characters) for which evolution has become newly enabled by a recent update to the game or an update within a prescribed period of time (within one month, for example).

In the above, one or more embodiments comprises a storage means 40 for storing possessed content possessed by a player, an extraction means 44 for extracting evolvable content that can be evolved from among the possessed content, a specification means 46 for specifying game disciplines that can be selected by the player and that are related to the evolution of the evolvable content, and a control means 42 for outputting a selection screen for receiving a selection of game disciplines to be played by the player, wherein the control means 42 outputs the specified game discipline in a different form from other game disciplines in the selection screen.

According to one or more embodiments, the server device 10 includes the CPU 22 and the storage 28 that stores: game tasks of a game to be played by a player; and game contents associated with a player ID of the player as possessed contents possessed by the player. The CPU 22 extracts, from the possessed contents, an evolvable content that can be evolved. The CPU 22 determines, from the game tasks, first game tasks that can be selected by the player. The CPU 22 causes a display to display a selection screen indicating the first game tasks and that receives a game task selected, from the first game tasks, by the player. The CPU 22 further determines, from the first game tasks, a second game task related to an evolution of the evolvable content. The selection screen indicates the second game task in a different form from remaining game tasks except for the second game task.

According to this configuration, the control means 42 displays, in the selection screen for selecting a game discipline, the game disciplines related to the evolution of the evolvable content in different forms, so that the player is not confused about the game to be played. This can increase the player's motivation to play a certain game discipline.

In one or more embodiments, the control means 42 may output the fact that the specified game discipline is related to the evolution of the evolvable content in the selection screen.

According to this configuration, the control means 42 displays, in the selection screen for selecting a game discipline, the fact that it is related to the evolution of the evolvable content, so that the player's motivation to evolve the evolvable content can be increased.

In one or more embodiments, the control means 42 may register in advance the evolvable content that said player wishes to evolve in response to the instructions for the evolvable content from the player, and the extraction means 44 may extract the registered evolvable content.

According to this configuration, since the extraction means 44 extracts the evolvable content registered in advance by the player, only the game disciplines related to the evolution of the evolvable content that the player wishes to evolve are displayed in a different form. As a result, this allows the player to see only the game disciplines related to the evolution of the evolvable content registered in advance, and the player will not be annoyed.

In one or more embodiments, the extraction means 44 may extract, from among possessed content, the evolvable content for which evolution has become newly enabled by an update to the game.

According to this configuration, the player can be informed of the evolvable content (possessed content) to which a new evolution destination has been added, thereby enabling increased motivation to evolve said evolvable content.

In one or more embodiments, the specification means 46 may specify, as a game discipline related to the evolution of the evolvable content, a game discipline for which resource content that is missing from the possessed content can be acquired, from among resource content related to evolvable content.

According to this configuration, this enables the player to see only the game disciplines in which there is resource content that the player does not possess that can be acquired, and the player will not be annoyed.

Also, in one or more embodiments, the specification means 46 may specify, as a game discipline related to the evolution of the evolvable content, a quest that is at a lower level than the quest that enables the evolution of said evolvable content upon completion and that the player has not yet completed.

This configuration provides the player with knowledge about which of the quests that have not yet been completed will enable the evolution of the evolvable content once completed, thereby increasing the player's motivation to play the quests.

In one or more embodiments, the specification means 46 may specify, as a game discipline related to the evolution of the evolvable content, a lottery game that is at a lower level than the lottery game for which the evolution of said evolvable content is enabled by playing and that the player has not yet played.

This configuration provides the player with knowledge about which lottery game among the lottery games that the player has not yet played will enable the evolution of the evolvable content by playing, thereby increasing the player's motivation to play the lottery game.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

For example, in one or more embodiment described above, the evolution conditions of the evolution fusion information in the character information 40B store the character IDs of one or a plurality of evolution resource characters associated with the character (fusion source character). However, the conditions may also store the lottery game IDs of lottery games to be played, the quest IDs of quests to be completed, the maximum level of a character, or a combination of some or all of the above. In this case, the specification means 46 may specify a quest for which completion is a condition for the evolution of a certain possessed character or a lottery game of which playing is a condition for the evolution of a certain possessed character as a game discipline related to the evolution.

In the embodiment described above, it is explained that the play requirements in the quest information 40C store the fact that a quest at one level lower has been completed or the like, but the play requirements may also store the fact that a quest at one level lower has been completed with a rating of a prescribed rank or higher (for example, with a rank of A or higher).

In the embodiment described above, it is explained that the play requirements in the lottery game information 40D store the fact that a lottery game at one level lower has been played or the like, but the play requirements may also store the fact that a specific character has been drawn in a lower level lottery game.

Also, in the embodiment described above, it is explained that the specification means 46 specifies a quest in which the missing evolution resource character can be acquired by referring to the enemy character information in the quest information 40C, but the specification means may also specify a quest with a high drop rate by referring to said drop rate of the enemy character information. Similarly, although it is explained that the specification means 46 specifies a lottery game in which the missing evolution resource character can be acquired by referring to the lottery target information in the lottery game information 40D, the specification means may also specify a lottery game with a high lottery probability by referring to said lottery probability of the lottery target information.

In the embodiment described above, it is explained that the control means 42 outputs game disciplines related to evolution in a different form from other game disciplines in the selection screen that shows the list of game disciplines, but the control means may indicate that the game disciplines are related to evolution only in the execution selection screen that shows the details of the game disciplines.

In the embodiment described above, although it is explained that the specification means 46 specifies game disciplines related to the evolution of an evolvable character from incremental game disciplines, the specification means may also specify non-incremental game disciplines (such as game disciplines with a set open period or game disciplines with no set play requirements). In this case, the control means 42 outputs said specified game discipline in a different form from the other game disciplines on the selection screen where the player selects a non-incremental game discipline.

In the embodiment described above, while it is explained that in the step SP18 described above, the specification means 46 specifies a selectable quest that is at a lower level than the evolution enabling quest as a quest indirectly related to evolution, if said selectable quest is at a lower level than said evolution enabling quest by a prescribed number or more (three or more for example), then said selectable quest may be specified as a quest that is not related to evolution.

Similarly, in the embodiment described above, while it is explained that in the step SP38 described above, the specification means 46 specifies a selectable lottery game that is at a lower level than the evolution enabling lottery game as a lottery game indirectly related to the evolution, if said selectable lottery game is a lottery game that is at a lower level than the evolution enabling lottery game by a prescribed number (three or more for example), said selectable lottery game may be specified as a lottery game not related to evolution.

In the embodiment described above, while the control means 42 sets incremental quests that the player has completed as quests that the player can select, quests that the player has completed may be set to non-selectable.

Similarly, in the embodiment described above, the control means 42 sets the incremental lottery games that the player has played as lottery games that the player can select, but the lottery games that the player has played may be set to non-selectable.

In the embodiment described above, it is explained that the extraction means 44 extracts an evolvable character that can be evolved from among the possessed characters of the player, but the extraction means may also extract a character whose ability parameters such as skill level can be increased. For example, by referring to the possessed character information in the player information 40A and the skill level in character information 40B, the extraction means 44 extracts a character whose skill level has not reached a maximum value from among the possessed characters as a character whose skill level can be increased. The specification means 46 then specifies the game disciplines in which characters in the same family as those whose skill levels can be increased can be acquired by referring to the enemy character information in the quest information 40C and the lottery target information in the lottery game information 40D. Then, the control means 42 outputs said specified game discipline in a different form from other game disciplines on the game discipline selection screen as being a game discipline related to increasing skill level.

While the embodiment described above explains characters as being used as an example of content, items (including weapons and armor), cards, avatars, coins, points, and the like can also be forms of content.

10 Server device (information processing device)

12 Terminal device (computer)

14 Game program (program)

40 Storage means

42 Control means

44 Extraction means

46 Specification means

What is claimed is:

1. An information processing device, comprising:
a storage that stores:
game tasks of a game to be played by a player; and
game contents associated with a player ID of the player as possessed contents possessed by the player; and
a processor connected to the storage and a display and that:
extracts, from the possessed contents, an evolvable content that can be evolved;
determines, from the game tasks, first game tasks that can be selected by the player; and
causes a display to display a selection screen indicating the first game tasks and that receives a game task selected, from the first game tasks, by the player, wherein
the processor further determines, from the first game tasks, a second game task related to an evolution of the evolvable content, and
the selection screen indicates the second game task in a different form from remaining game tasks except for the second game task.

2. The information processing device according to claim 1, wherein the processor causes the display that that the second game task is related to the evolution of the evolvable content on the selection screen.

3. The information processing device according to claim 1, wherein
the storage registers in advance an evolvable content that the player wishes to evolve according to an instruction for the evolvable content from the player, and
the processor extracts the registered evolvable content.

4. The information processing device according to claim 1, wherein the processor extracts, from the possessed contents, another evolvable content for which evolution has become newly enabled by an update to the game.

5. The information processing device according to claim 1, wherein
the storage stores resource contents associated with the evolvable content,
the processor determines whether the resource contents comprise a first resource content that is not associated with the player ID, and
if the processor determines that the resource contents comprises the first resource content, the processor causes the display to display a game task for which the first resource content can be acquired.

6. The information processing device according to claim 1, wherein
the game tasks are quests that enable an evolution of the evolvable content upon completion,
the quests comprise a first quest and a second quest that can be played after the first quest is completed by the player,
the processor determines whether the second quest has been completed by the player, and
if the processor determines that the second quest has not been completed by the player, the processor causes the display to display the second quest on the selection screen.

7. The information processing device according to claim 1, wherein
the game tasks are lottery games that enable an evolution of the evolvable content,
the lottery games comprise a first lottery game and a second lottery game that can be played after the first lottery game is played,
the processor determines whether the second lottery game has been played by the player, and
if the processor determines that the second lottery game has not been completed by the player, the processor causes the display to display the second lottery game on the selection screen.

8. A non-transitory computer-readable medium (CRM) that stores program instructions that causes a computer to perform an operation to function as an information processing device, the operation comprising causing the computer to:
store, with a storage of the computer:
game tasks of a game to be played by a player; and
game contents associated with a player ID of the player as possessed contents possessed by the player,
extract, from the possessed contents, an evolvable content that can be evolved,
determine, from the game tasks, first game tasks that can be selected by the player, and
cause a display to display a selection screen indicating the first game tasks and that receives a game task selected, from the first game tasks, by the player,
determine, from the first game tasks, a second game task related to an evolution of the evolvable content, wherein
the selection screen indicates the second game task in a different form from remaining game tasks except for the second game task of the first game tasks.
